(19) United States
(12) Patent Application Publication
(10) Pub. No.: US 2007/0013939 A1
(43) Pub. Date: Jan. 18, 2007

(54) Printer

(75) Inventor: Yoshihiro Yoshikawa, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/483,645

(22) Filed: Jul. 11, 2006

(30) Foreign Application Priority Data
Jul. 13, 2005 (JP) 2005-204690

(51) Int. Cl. G06K 15/00

(52) U.S. Cl. 358/1.14; 358/1.13

(57) ABSTRACT

A printer has an image receiving section, a recording mode selecting section, an image drawing section and an error alerting section. The recording mode selecting section selects either one of a first recording mode and a second recording mode. In the first recording mode only an image based on the image data received by the image receiving section is recorded, and in the second recording mode additional data added to the image data is recorded together with the image data. The error alerting section issues an error alert and the image drawing section withholds image drawing, when the image data received by the image receiving section represent the image data without the additional data, even though the second recording mode is selected by the recording mode selecting section and.

### BACKGROUND OF THE INVENTION

1. Field of the Invention

The present invention relates to a printer configured to draw an image on a recording medium for recording images while feeding the recording medium and thereby to record the image on the recording medium.

2. Description of the Related Art

A printer configured to record images on instant photographic sheets has heretofore been known. This printer includes a pack chamber for loading an instant film pack which contains multiple stacked instant photographic sheets. Moreover, this printer also includes mechanical sections including a claw that locks one of the instant photographic sheets inside the pack chamber at a tail end in the feeding direction thereof and that picks up the instant photographic sheet in the feeding direction, and a cam that assists the picking operation of the claw, for example.

To record an image on the instant photographic sheet, the tail end of one of the instant photographic sheets inside the pack chamber is picked up with the claw and the sheet is fed with a feed roller, and light from a light-emitting element is irradiated on the instant photographic sheet to draw a latent image. Then, process liquid puddles contained in the instant photographic sheet are crushed with a spread roller to spread the process liquid.

Similarly, a printer which allows addition of a date of shooting to an appropriate position on an image has been disclosed, for instance, in Japanese Patent Application Publication No. 2002-27229 as the printer configured to draw an image on a recording medium such as an instant photographic sheet for recording images while feeding the recording medium, and thereby to record the image on the recording medium.

In terms of the printer disclosed in Japanese Patent Application Publication No. 2002-27229, an image is recorded on the recording medium based on image data from a portable memory card which is detachably loaded on the printer, from a digital camera to be connected to the printer through a cable, or from a personal computer, for example. Among such image data, there may be some image data which do not contain date data of shooting. Here, if a user intends to record an image with addition of a date of shooting on a recording medium without knowing that the image data do not contain the date of shooting, an image without addition of the date data of shooting may be recorded on the recording medium. Accordingly, there is a problem that an image unintended by the user is recorded on the recording medium.

### SUMMARY OF THE INVENTION

The present invention has been made in view of the above circumstances and provides a printer which can prevent an image unintended by a user from being recorded on a recording medium.

A first aspect of the present invention provides a printer configured to draw an image on a recording medium for recording images while feeding the recording medium and thereby to record the image on the recording medium, the printer including an image receiving section that receives image data; a recording mode selecting section that selects either one of a first recording mode and a second recording mode, in the first recording mode only an image based on the image data being recorded, in the second recording mode additional information based on additional data added to the image data being recorded together with the image based on the image data; an image drawing section that draws either one of the image and both the image and the additional information in accordance with a recording mode selected by the recording mode selecting section; and an error alerting section that issues an error alert when the image data received by the image receiving section represent the image data without the additional data even though the second recording mode is selected by the recording mode selecting section. Here, the image drawing section withholds image drawing when the image data received by the image receiving section represent the image data without the additional data even though the second recording mode is selected by the recording mode selecting section.

The printer according to the first aspect of the present invention is configured to issue an error alert to a user instead of image drawing when the image data received by the image receiving section represent the image data without the additional data even though the recording mode selecting section selects the second recording mode to record the additional information based on the additional data added to the image data together with the image based on the image data. Accordingly, an image without additional information such as a date will not be recorded on a recording medium, and a user can confirm the lack of the additional information by an alert. Therefore, it is possible to prevent an image unintended by the user from being recorded on the recording medium.

Meanwhile, a second aspect of the present invention provides a printer configured to draw an image on a recording medium for recording images while feeding the recording medium and thereby to record the image on the recording medium, the printer including an image receiving section that receives image data; a recording mode selecting section that selects either one of a first recording mode and a second recording mode, in the first recording mode only an image based on the image data being recorded, in the second recording mode additional information based on additional data added to the image data being recorded together with the image based on the image data; an image drawing section that draws either one of the image and both the image and the additional information in accordance with a recording mode selected by the recording mode selecting section; and an error alerting section that issues an error alert when the image data received by the image receiving section represent the image data without the additional data even though the second recording mode is selected by the recording mode selecting section. Here, the image drawing section performs image drawing in accordance with the first recording mode when the image data received by the image receiving section represent the image data without the additional data even though the second recording mode is selected by the recording mode selecting section.

There may be a case where a user intends to record an image based on image data even if the image data do not contain additional information such as a date. The printer according to the second aspect of the present invention is configured to perform image drawing in accordance with the first recording mode to record only the image based on the image data when the image data received by the image receiving section represent the image data without the additional data even though the recording mode selecting section selects the second recording mode to record the additional information based on the additional data added to the image data together with the image based on the image data. Meanwhile, an error alert will be issued to the user. Accordingly, it is possible to record an image on a recording medium based on image data even if the image data do not contain additional information such as a date, and a user can confirm the lack of the additional information by an alert.

Moreover, a third aspect of the present invention provides a printer configured to draw an image on a recording medium for recording images while feeding the recording medium and thereby to record the image on the recording medium, the printer including: an image receiving section that receives image data; a recording mode selecting section that selects either one of a first recording mode and a second recording mode, in the first recording mode only an image based on the image data being recorded, in the second recording mode additional information based on additional data added to the image data being recorded together with the image based on the image data; an image drawing section that draws either one of the image and both the image and the additional information in accordance with a recording mode selected by the recording mode selecting section; an error alerting section that issues an error alert when the image data received by the image receiving section represent the image data without the additional data even though the second recording mode is selected by the recording mode selecting section; and a timer that manages a date. Here, the image drawing section draws the date managed by the timer together with the image based on the image data received by the image receiving section when the image data received by the image receiving section represent the image data without addition of the date data even though the second recording mode is selected by the recording mode selecting section.

The printer according to the third aspect of the present invention is configured to issue an error alert to a user concerning the lack of the date data when the image data received by the image receiving section represent the image data without addition of the date data even though the recording mode selecting section selects the second recording mode to record the date based on the date data, and to draw the image based on the image data received by the image receiving section and the date managed by the timer. Accordingly, even if the image data received by the image receiving section do not contain the date data, the date is still drawn together with the image based on the image data. Therefore, an image with addition of a date is recorded on a recording medium when the user intends to record the image with addition of the date even without knowing that the image data do not contain the date data. In this way, it is possible to prevent an image unintended by the user from being recorded on the recording medium.

Meanwhile, a fourth aspect of the present invention provides a printer configured to draw an image on a recording medium for recording images while feeding the recording medium and thereby to record the image on the recording medium, the printer including: a receiving section that receives image data which occasionally contain additional data and receives data corresponding to the additional data independently of the image data; a recording mode selecting section that selects either one of a first recording mode and a second recording mode, in the first recording mode only an image based on the image data being recorded, in the second recording mode additional information based on additional data added to the image data being recorded together with the image based on the image data; an image drawing section that draws either one of the image and both the image and the additional information in accordance with a recording mode selected by the recording mode selecting section; and an error alerting section that issues an error alert when the image data received by the receiving section represent the image data without the additional data even though the second recording mode is selected by the recording mode selecting section. Here, the image drawing section draws the additional data based on the data corresponding to the additional data received by the receiving section prior to reception of the image data together with the image based on the image data received by the receiving section.

The printer according to the fourth aspect of the present invention is configured to issue an error alert when the image data received by the receiving section represent the image data without the additional data even though the second recording mode is selected, and to draw the additional information based on the addition correspondent data received prior to reception of the image data by the receiving section on the recording medium together with the image based on the image data received by the receiving section. Accordingly, an image without the additional information will not be recorded on a recording medium, and it is possible to prevent an image unintended by a user from being recorded on the recording medium.

According to the present invention, it is possible to provide a printer capable of preventing an image unintended by a user from being recorded on a recording medium.

### BRIEF DESCRIPTION OF THE DRAWINGS

FIG. 1 is a perspective view of a printer according to a first embodiment of the present invention, viewed from diagonally above its front face.

FIG. 2 is a view showing an aspect in which an instant photographic sheet with an image recorded based on image data from a camera-equipped cellular telephone is discharged from the printer shown in FIG. 1.

FIG. 3 is a perspective view of the printer shown in FIG. 1, viewed from diagonally above its bottom face side.

FIG. 4 is a perspective view of the printer shown in FIG. 3 in a state of opening a film door.

FIG. 5 is a perspective view of the printer shown in FIG. 4 in a state of detaching an enclosure.

FIG. 6 is a perspective view showing an exposure surface of an instant photographic sheet.

FIG. 7 is a perspective view showing an observation surface of the instant photographic sheet.

FIG. 8 is a cross-sectional view of a medium feeding-developing section.

FIG. 9 is a block diagram showing a control system inside the printer.

FIG. 10 is a flowchart of a series of processing routines by the printer shown in FIG. 9.

FIG. 11 is a block diagram showing a control system inside a printer according to a second embodiment of the present invention.

FIG. 12 is a flowchart of a series of processing routines by the printer shown in FIG. 11.

FIG. 13 is a block diagram showing a control system inside a printer according to a third embodiment of the present invention.

FIG. 14 is a flowchart of a series of processing routines by the printer shown in FIG. 13.

FIG. 15 is a block diagram showing a control system inside a printer according to a fourth embodiment of the present invention.

FIG. 16 is a flowchart of a series of processing routines by the printer shown in FIG. 15.

### DETAILED DESCRIPTION OF THE INVENTION

Embodiments of the present invention will now be described below.

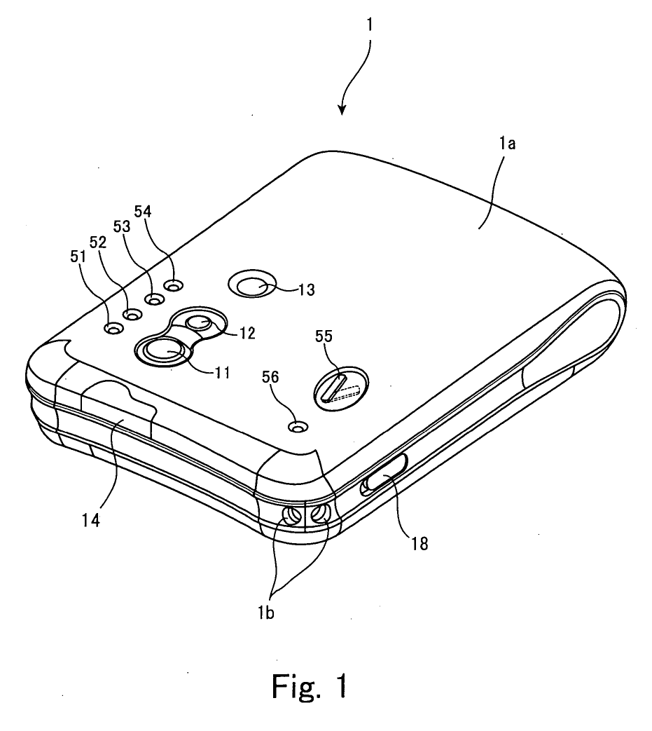

FIG. 1 is a perspective view of a printer according to a first embodiment of the present invention, viewed from diagonally above its front face.

This printer 1 is used in combination with a cellular telephone or the like, and is configured to load an instant film pack containing multiple stacked sheets (hereinafter explained in the case of ten sheets) of instant photographic sheets designed to form latent images thereon by exposure and to visualize the latent images by spreading a process liquid in the course of discharge, to subject the instant photographic sheets to light exposure according to image data, and to spread the process liquid on the instant photographic sheets while discharging the instant photographic sheets to outside. The instant photographic sheet corresponds to an example of a recording medium in the present invention.

There are cellular telephones capable of performing infrared communication based on the Infrared Data Association (IrDA) standard. Such a cellular telephone is able to transmit information held therein to another information device by use of the infrared communication. If the cellular telephone is equipped with a camera, the cellular telephone is able to transmit image data to the printer 1. The printer 1 is configured to record an image on an instant photographic sheet, when image data are transmitted to the printer 1 by use of the infrared communication, based on image data representing the image taken by the camera-equipped cellular telephone or on image data transmitted to the cellular telephone through an electronic mail or the like. Moreover, the printer 1 is capable of re-recording the image on another instant photographic sheet based on the transmitted image data by just repeating switch to be described later without requiring re-transmission from the cellular telephone.

As shown in FIG. 1, the printer 1 is a portable printer having thin-profile, lightweight, and small structures. Two 3-V primary batteries are mounted in the printer 1. The instant film pack is loaded in an enclosure 1a of the printer 1, and each of the ten instant photographic sheets stacked in the instant film pack is subjected to image recording.

A power switch (hereinafter referred to as a power SW) 11 for commanding application of power to and shutoff thereof from the printer 1, and a repeat switch (hereinafter referred to as a repeat SW) 12 for re-recording the image based on the transmitted image data are provided as operating buttons on an upper face of the enclosure 1a of the printer 1. Moreover, a counter 13 for indicating the number of the remaining instant photographic sheets is provided on the upper face of the enclosure 1a. This counter 13 is a mechanical counter on which a numerical value ‘10’ indicating that the number of the remaining sheets is equal to ten is displayed when loading a new instant film pack. Thereafter, a subtracted numerical value indicating the number of the remaining sheets is displayed every time the instant photographic sheet is subjected to image recording, and a numerical value ‘0’ indicating that there is no remaining sheet is displayed when the tenth instant photographic sheet is subjected to image recording. Here, the counter 13 is set to a blank state of displaying nothing when the instant film pack is pulled out.

Moreover, a transmission-reception window 14 is provided at an end of the printer 1. An IrDA transmitting and receiving section to be described later, which plays a role as an image receiving section in the present invention, is provided inside the transmitting-receiving window 14. This IrDA transmitting and receiving section receives the image data transmitted via the infrared communication and transmits back a signal for acknowledging the receipt.

Further, the enclosure 1a of the printer 1 is provided with a power light emitting diode (LED) 51 which is turned on at the time of power application, a pilot LED 52 which is turned on at the time of the infrared communication, a communication error LED 53 which is turned on upon occurrence of an error in the infrared communication, and a low battery display LED 54 which is turned on for urging a user to replace batteries at the time of battery voltage reduction.

Meanwhile, the enclosure 1a of the printer 1 is also provided with a date selection switch 55 (which corresponds to an example of a recording mode selecting section in the present invention). This date selection switch 55 selects one mode out of a first recording mode and a second recording mode; in the first recording mode, only the image based on the image data is recorded on the instant photographic sheet; in the second recording, additional information based on additional data added to the image data is recorded together with the image based on the image data. Here, in addition to the date, the additional information may include shooting information such as a shutter speed or an aperture value, desired comment information, and the like. Further, the enclosure 1a of the printer 1 is also provided with a date selection LED 56 which is turned on in the case of selecting the second recording mode by the date selection switch 55, i.e., in the case of selecting the recording mode to record the date together with the image.

Meanwhile, a film door open switch 18 for opening a film door to be described later, which is formed on a bottom face side of the printer 1, is provided on a side face of the printer 1. A strap fitting section 1b is provided on a corner section.

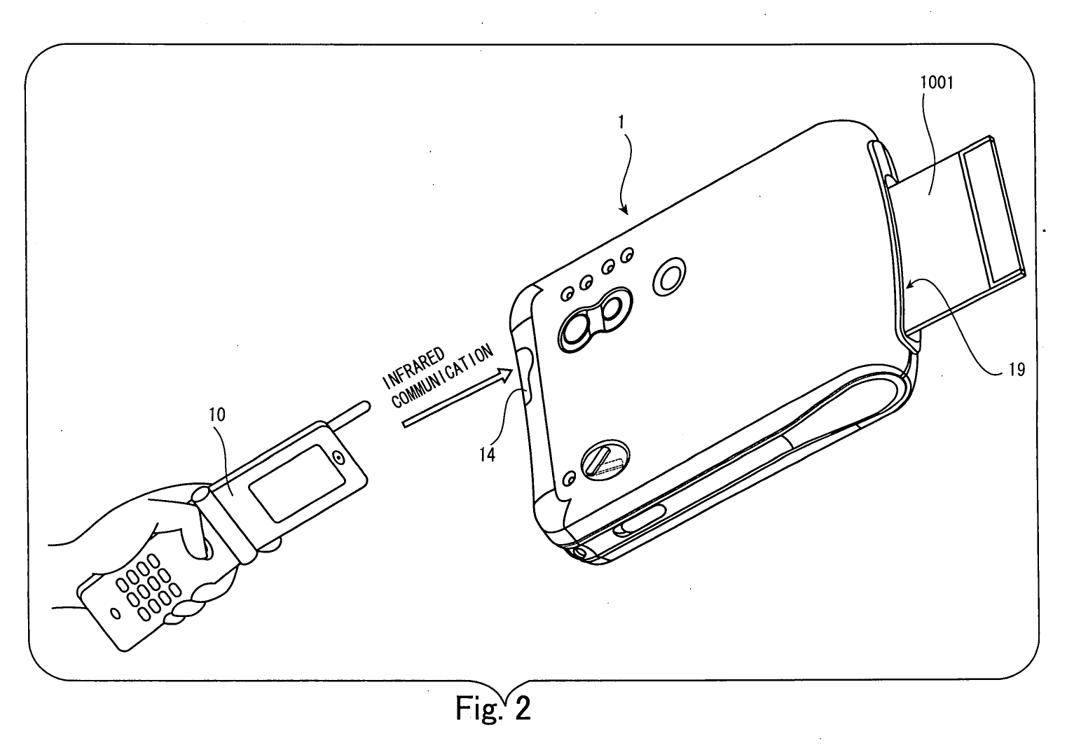

FIG. 2 is a view showing an aspect in which an instant photographic sheet with an image recorded based on image data from a camera-equipped cellular telephone is discharged from the printer shown in FIG. 1.

While directing an infrared communicating section of a camera-equipped cellular telephone 10 toward the transmitting-receiving window 14 of the printer 1, the camera-equipped cellular telephone 10 is operated to transmit image data representing an image taken by the camera-equipped cellular telephone 10 to the printer 1 by use of the infrared communication. The printer 1 receives the image data transmitted by the infrared communication and records a latent image based on the received image data on an instant photographic sheet 1001 by way of exposure. Simultaneously, the printer 1 visualizes the latent image and discharges the instant photographic sheet 1001 gradually from a delivery port 19 to outside. Thereafter, the same image as the foregoing image is re-recorded on another instant photographic sheet when the repeat SW 12 is operated.

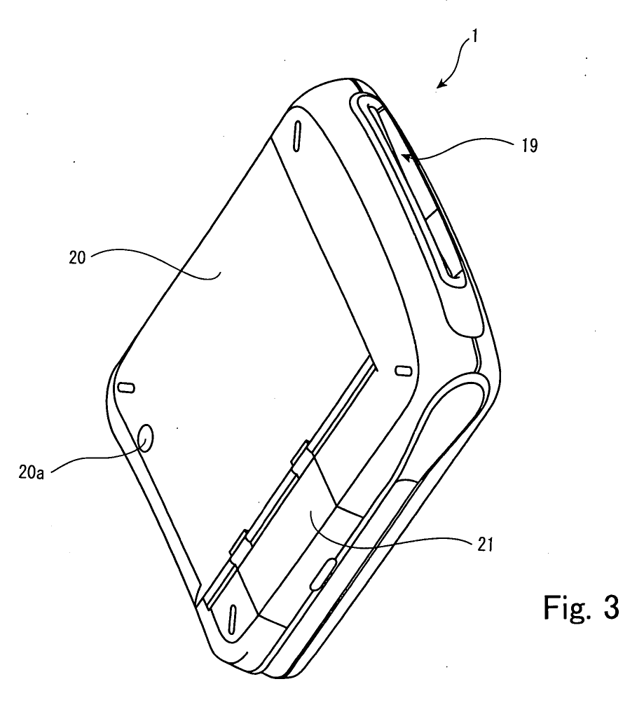

FIG. 3 is a perspective view of the printer shown in FIG. 1, viewed from diagonally above its bottom face side.

A film door 20 configured to be opened by an operation of the film door open switch 18 shown in FIG. 2 is provided on the bottom face side of the printer 1, and the film door 20 is opened when the instant film pack is loaded in a pack chamber. Moreover, the film door 20 is provided with a pack presence check window 20a for checking whether the instant film pack is loaded or not. In addition, a battery lid 21 to be opened for loading batteries that serves as a power source for the printer 1 is located adjacent to the film door 20.

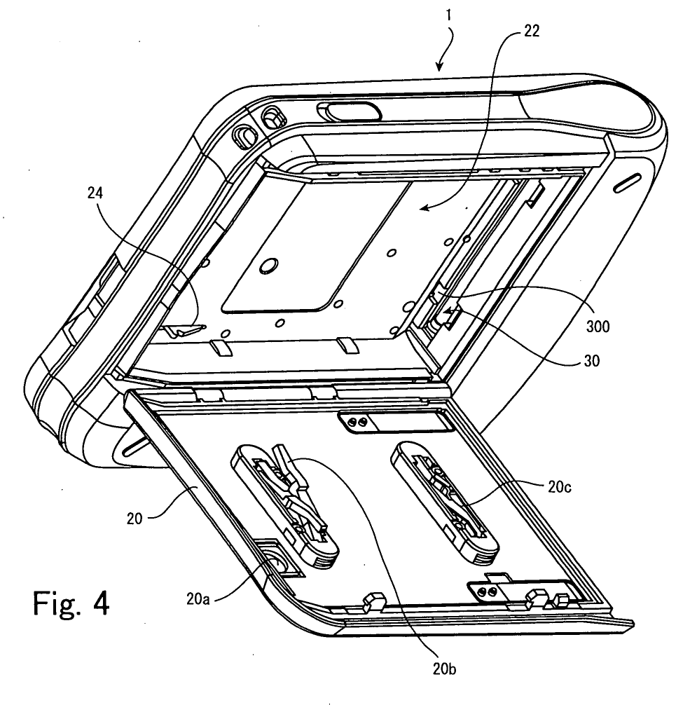

FIG. 4 is a perspective view of the printer shown in FIG. 3 in a state of opening the film door.

The pack presence check window 20a and spring members 20b and 20c are provided inside the film door 20. The instant photographic sheets stacked inside the instant film pack are pressed against a top face side of the printer 1 by these spring members 20b and 20c.

Moreover, the printer 1 is provided with a pack chamber 22 for loading the instant film pack. An image drawing section 300, which draws an image on an instant photographic sheet subject to feeding, and a medium feeding-developing section 30 are provided on the right hand outside the pack chamber 22 in FIG. 4. Details of the image drawing section 300 and the medium feeding-developing section 30 will be described later. Moreover, a claw 24 for sending the instant photographic sheet to the image drawing section 300 and the medium feeding-developing section 30 is provided inside the pack chamber 22 at a lower part in FIG. 4. By this configuration, the instant photographic sheet in the instant film pack, which sheet is located closest to the top face of the printer 1 is picked up by the claw 24 and fed by the medium feeding-developing section 30. At the same time, the image is drawn on the instant photographic sheet by the image drawing section 300 and that image is subjected to development.

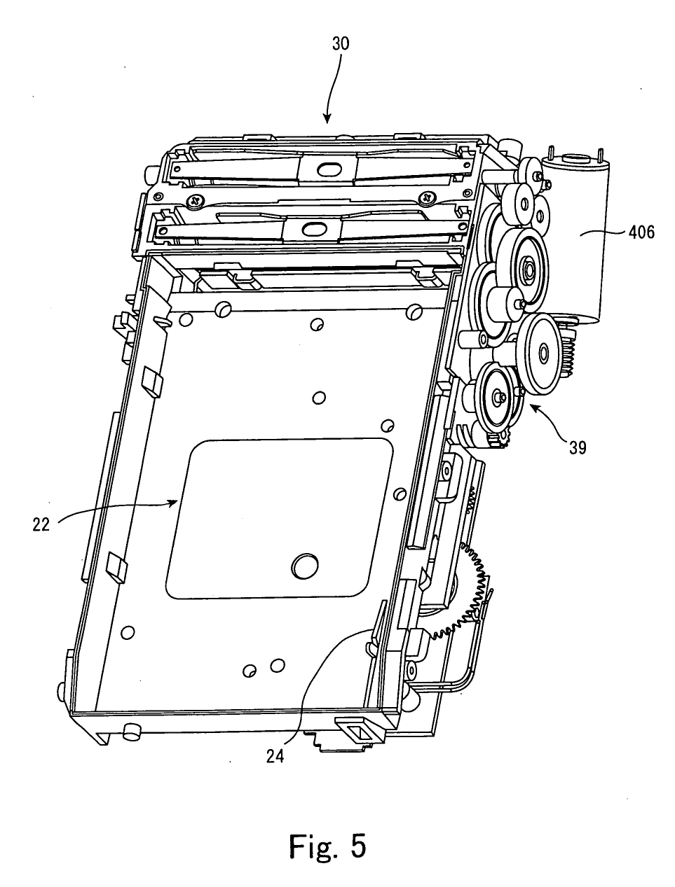

FIG. 5 is a perspective view of the printer shown in FIG. 4 in a state of detaching the enclosure.

FIG. 5 illustrates the medium feeding-developing section 30 which includes a direct-current motor 406 and a gear array 39 for transmitting a rotary drive force from the direct-current motor 406 to feed rollers and spread rollers to be described later. Meanwhile, FIG. 5 also illustrates the claw 24 located inside the pack chamber 22.

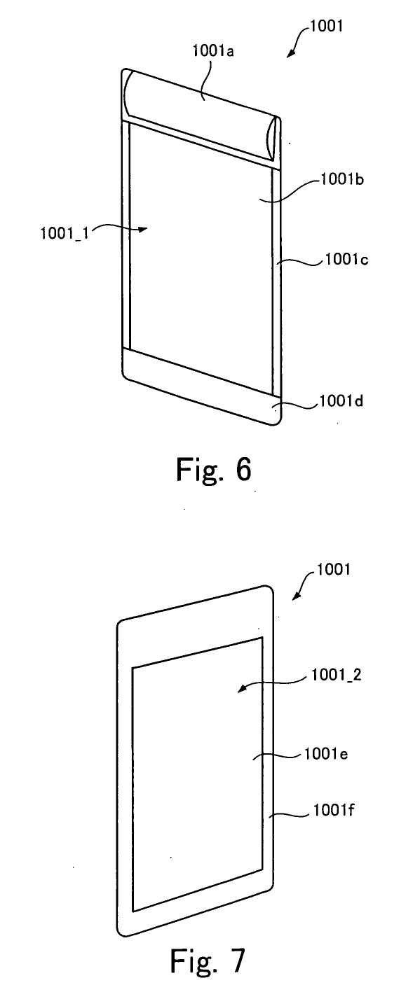

FIG. 6 is a perspective view showing an exposure surface of the instant photographic sheet, and FIG. 7 is a perspective view showing an observation surface of the instant photographic sheet.

FIG. 6 shows an exposure surface 1001_1 of the instant photographic sheet 1001. A process liquid puddle 1001a located on a leading edge in the feeding direction of the instant photographic sheet 1001, an exposure section 1001b on which the image is exposed, a margin section 1001c, and a trap section 1001d for absorbing the remaining process liquid are provided on the exposure surface 1001_1. Meanwhile, FIG. 7 shows an observation surface 1001_2 of the instant photographic sheet 1001. An observation section 1001e for observing the image, which is visualized as a result of spreading the process liquid on the latent image formed by the exposure, and a margin section 1001f are provided on the observation surface 1001_2.

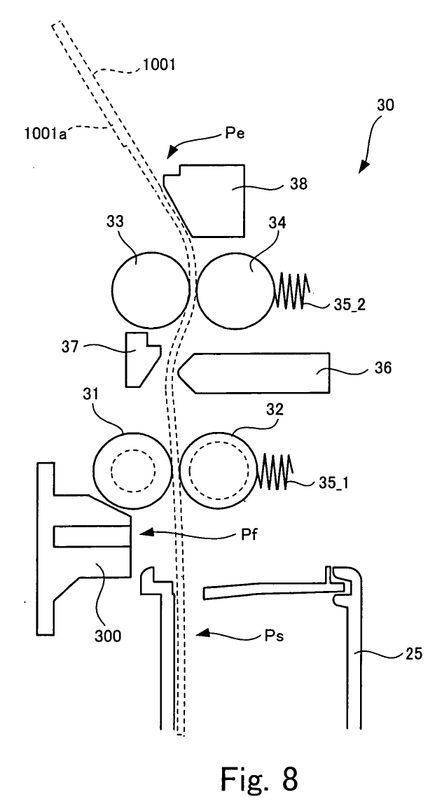

FIG. 8 is a cross-sectional view of the medium feeding-developing section.

The medium feeding-spreading section 30 includes a pair of feed rollers 31 and 32 configured to sandwich both sides of the instant photographic sheet 1001 and thereby to feed the instant photographic sheet 1001. The feed roller 32 is biased toward the feed roller 31 by a spring member 35_1.

Meanwhile, the medium feeding-developing section 30 includes a pair of spread rollers 33 and 34, which are located on a downstream side in the feeding direction of the instant photographic sheet 1001 relative to the pair of feed rollers 31 and 32, and which are configured to crush the process liquid puddle 1001a by sandwiching the instant photographic sheet 1001 across the full width for spreading the process liquid. The spread roller 34 is biased toward the spread roller 33 by a spring member 35_2.

Moreover, the medium feeding-developing section 30 includes control plates 36 and 37 located in spaces between the feed rollers 31,32 and the spread rollers 33,34. The control plates 36 and 37 are configured to control the process liquid in the spreading process. The medium feeding-spreading section 30 further includes a film guide frame 38 for guiding the instant photographic sheet 1001. Meanwhile, the image drawing section 300 is located in the vicinity of an exit of instant film pack 25.

The printer 1 of the embodiment picks up the instant photographic sheet 1001, which sheet is located closest to the top face of the printer 1, among the instant photographic sheets 1001 in the instant film pack 25, at a given feeding start point Ps by use of the claw 24 (see FIG. 4 and FIG. 5). Then, the printer 1 starts image drawing at a fixed drawing point Pf while feeding the sheet with the feed rollers 31 and 32. Moreover, the printer 1 further feeds the instant photographic sheet 1001 with the feed rollers 31 and 32 simultaneously with further drawing the image on the instant photographic sheet 1001, spreads the process liquid by crushing the process liquid puddle 1001a with the spread rollers 33 and 34, performs development by controlling the process liquid in the spreading process with the control plates 36 and 37, and feeds the instant photographic sheet 1001 to a given feeding end point Pe. In this way, the image is recorded on the single instant photographic sheet 1001.

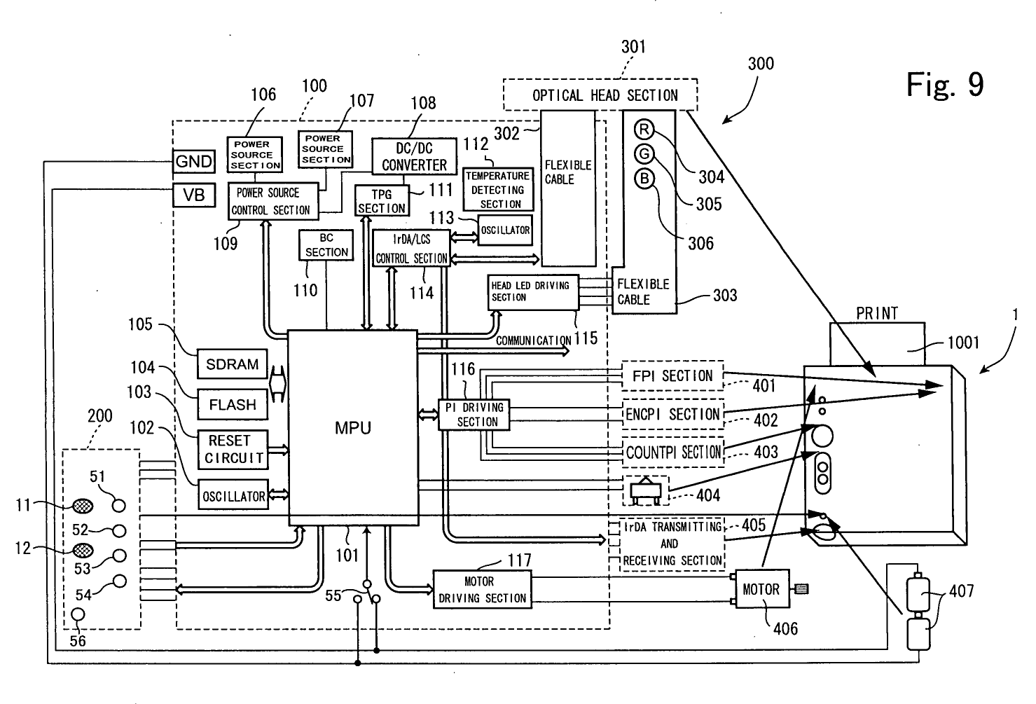

FIG. 9 is a block diagram showing a control system inside the printer.

A schematic view of the printer 1 shown in FIG. 1 is illustrated on the right end in FIG. 9, and a configuration of a control system of the printer 1 is illustrated on the remaining part in FIG. 9 except the right end. Note that arrows shown in FIG. 9 indicate layout relations of respective constituents representing the control system in the printer 1.

This printer 1 includes a main board section 100, a sub board section 200, the image drawing section 300, an FPI section 401, an ENCPI section 402, a COUNTPI section 403, a cam switch 404, an IrDA transmitting and receiving section 405 provided on the transmitting-receiving window 14, and the direct-current motor 406.

The sub board section 200 includes the power SW 11, the repeat SW 12, the power LED 51, the pilot LED 52, the communication error LED 53, the low battery display LED 54, and the date selection LED 56. Moreover, the date selection switch 55 is connected to a micro processor unit (MPU) 101 to be described later.

The image drawing section 300 includes an optical head section 301 provided with an optical guide, a liquid crystal shutter (LCS) and the like, flexible cables 302 and 303 for connecting the optical head section 301 to the main board section 100, and light emitting diodes (LEDs) 304, 305 and 306 respectively having emission colors of red (R), green (G) and blue (B) which are mounted on the flexible cable 303. This image drawing section 300 draws a latent image on the instant photographic sheet 1001 in the feeding process based on the image data received by the IrDA transmitting and receiving section 405 synchronously with drawing instruction pulses and in accordance with the recording mode selected by the date selection switch 55, by means of cyclically irradiating light in the three colors of R, G, and B from the LEDs 304, 305, and 306 and thereby drawing only the image or both of the image and the date on the instant photographic sheet 1001. Here, the image drawing section 300 is operated so as to withhold drawing of the latent image on the instant photographic sheet 1001, when the image data received by the IrDA transmitting and receiving section 405 represent the image data without addition of date data even though the second recording mode, in which the date added to the image data is recorded together with the image based on the image data, is selected by the date selection switch 55. Moreover, when the image data received by the IrDA transmitting and receiving section 405 represent the image data without addition of date data even though the second recording mode is selected, the date selection LED 56 blinks for issuing an error alert to a user. In this way, the date selection LED 56 plays a role as an error alerting section in the present invention by performing a blink display. Meanwhile, two 3-V primary batteries 407 are mounted in the printer 1.

The printer 1 according to the first embodiment of the present invention is configured to withhold image drawing and to issue the error alert to the user instead when the image data received by the IrDA transmitting and receiving section 405 represent the image data without addition of the date data, even though the second recording mode is selected. For this reason, an image without the date is not recorded on the instant photographic sheet 1001 and an error alert is issued. Therefore, it is possible to prevent the image unintended by the user from being recorded on the instant photographic sheet 1001. More details will be described below.

A power voltage VB at 6 V is applied from the primary batteries 407 connected in series to the main board section 100. This main board section 100 includes the MPU 101, an oscillator 102, a reset circuit 103, a flash memory (FLASH) 104, and a synchronous dynamic random access memory (SDRAM) 105.

The MPU 101 integrally controls operations of the printer 1.

The oscillator 102 generates an oscillation signal at a given frequency and supplies the signal to the MPU 101 as an operating clock signal.

The reset circuit 103 outputs a reset signal for initializing the MPU 101.

The flash memory 104 is a non-volatile memory. Adjusted values for adjusting individual differences, which values are determined based on mechanisms unique to the printer 1 for example, are stored in the flash memory 104.

The SDRAM 105 is a volatile memory. The image data from the camera-equipped cellular telephone 10, for example, are stored in the SDRAM 105.

Meanwhile, the main board section 100 includes a power source section 106 which outputs a voltage at 2.5 V, a power source section 107 which outputs a voltage at 3.3 V, and a direct-current/direct-current (DC/DC) converter 108 which outputs a voltage at 15 V, while accepting the power voltage VB at 6 V. Moreover, the main board section 100 also includes a power source control section 109 which controls the power source sections 106 and 107 as well as the DC/DC converter 108 upon receipt of an instruction from the MPU 101. Here, the voltage at 2.5 V is supplied to the MPU 101 while the voltage at 3.3 V is supplied to peripheral circuits other than the MPU 101. Meanwhile, the voltage at 15 V is supplied to drive an LCD.

This printer 1 includes the MPU 101 having a standby mode, which is a low power consumption mode for extending duration of the primary batteries 405. Accordingly, even in the case of pressing the power SW 12, the printer 1 is set to the standby mode at the point of completion of initial processing. When the infrared communication from outside is carried out in this state, the printer 1 is switched from the standby mode to a normal operating mode and records the image on the instant photographic sheet, and then switched from the normal operating mode to the standby mode promptly. Similarly, in the case of pressing the repeat SW 12, the printer is set to the standby mode after recording the image on the instant photographic sheet. Further, the MPU 101 controls the power source sections 106 and 107 as well as the DC/DC converter 108 through the power source control section 109 so as to allow the MPU 101 to supply electricity to the respective sections only when the electricity is necessary. In this way, it is possible to use the printer 1 for a longer period by use of the mounted primary batteries 407.

Moreover, the main board section 100 includes a BC section 110, a TPG section 111, a temperature detecting section 112, an oscillator 113, an IrDA/LCS control section 114, and a head LED driving section 115.

The BC section 110 checks whether or not the power voltage VB of the primary batteries 407 falls below a predetermined value. When the MPU 101 makes reference to a result of this check and determines that the power voltage VB of the primary batteries 407 falls blow the predetermined value, the MPU 101 turns the low battery display LED 54 on to urge the user to replace batteries.

The TPG section 111 turns on and off the 15 V voltage outputted from the DC/DC converter 108.

The temperature detecting section 112 detects a temperature of the image drawing section 300. The MPU 101 controls shutter speeds of respective shutter sections in the liquid crystal shutter inside the optical head section 301, for example, in response to a detection signal from this temperature detecting section 112.

The oscillator 113 generates an oscillation signal at a given frequency and supplies the signal to the IrDA/LCS control section 114.

The IrDA/LCS control section 114 controls the IrDA transmitting and receiving section 405 and the optical head section 301 based on the oscillation signal from the oscillator 113. The IrDA transmitting and receiving section 405 includes a light emitting element and a light receiving element for performing the infrared communication. The IrDA/LCS control section 114 transmits data subjected to photoelectric conversion by the light receiving element to the MPU 101, or transmits data for informing an external device of the transmission of the data subjected to photoelectric conversion to the outside through the light emitting element. Moreover, the IrDA/LCS control section 114 controls the liquid crystal shutter included in the optical head section 301 through the flexible cable 302 based on an instruction from the MPU 101.

The head LED driving section 115 supplies electric currents based on instructions from the MPU 101 to the LEDs 304, 305, and 306 through the flexible cable 303, and thereby drives the LEDs 304, 305, and 306.

The printer 1 of the embodiment is a printer configured to record a color image on the instant photographic sheet 1001 by feeding the instant photographic sheet 1001 in a given sub-scanning direction (the feeding direction of the instant photographic sheet 1001) with the direct-current motor 406 and cyclically drawing the image in three colors of R, G, and B in terms of the sub-scanning direction on the instant photographic sheet 1001, and meanwhile, by performing image drawing in the same color simultaneously in a main scanning direction orthogonal to the sub-scanning direction in terms of all pixels arranged in the main scanning direction.

When the color image is recorded, control signals corresponding to the image data are supplied from the IrDA/LCS control section 114 to the optical head section 301 that constitutes the image drawing section 300 through the flexible cable 302. The control signals control shutter speeds of the respective shutter sections of the liquid crystal shutter in the optical head section 301. The shutter speeds of the respective shutter sections are controlled according to the image data, whereby the light beams corresponding to the respective colors of R, G, and B are irradiated from the LEDs 304, 305, and 306 mounted on the flexible cable 303 onto the instant photographic sheet 1001. Thus, the latent image formed of numerous light spots (dots) spreading in the width direction of the instant photographic sheet 1001 is recorded. The width direction, i.e. the direction of one-dimensional arrangement of the respective shutter sections is the main scanning direction. Therefore, the respective shutter sections are electrically scanned in the main scanning direction, whereby the light spots (all the pixels) corresponding to one line are recorded on the instant photographic sheet 1001. By the electronic scanning using the optical head section 301, the light spots composed of the numerous dots are recorded in the main scanning direction of the instant photographic sheet 1001 by electronic scanning using the optical head section 301. Meanwhile, as described previously, the instant photographic sheet 1001 is sent in the sub-scanning direction by use of the direct-current motor 406. Therefore, light spots are sequentially recorded in the form of numerous dots by the image drawing section 300 in terms of the sub-scanning direction as well.

Moreover, the main board section 100 includes a PI driving section 116. This PI driving section 116 drives the FPI section 401, the ENCPI section 402, and the COUNTPI section 403. Now, the FPI section 401, the ENCPI section 402, and the COUNTPI section 403 will be described.

The FPI section 401 is a photointerrupter for detecting presence of the instant photographic sheet 1001.

The ENCPI section 402 is a photointerrupter for outputting an encoding signal composed of a pulse train synchronized with the rotation of the direct-current motor 406.

The COUNTPI section 403 is a photointerrupter for detecting a reset state (the state of detachment of the instant film pack) by the counter 13.

Meanwhile, the cam switch 404 is connected to the main board section 100. This cam switch 404 is a switch for monitoring an initial position in terms of a feeding mechanism of the printer 1.

Further, the main board section 100 includes a motor driving section 117. This motor driving section 117 controls a rotating speed of the direct-current motor 406 upon receipt of an instruction from the MPU 101 so as to render a time interval of the pulse train in the encoding signal outputted from the ENCPI section 402 equal to a predetermined time interval.

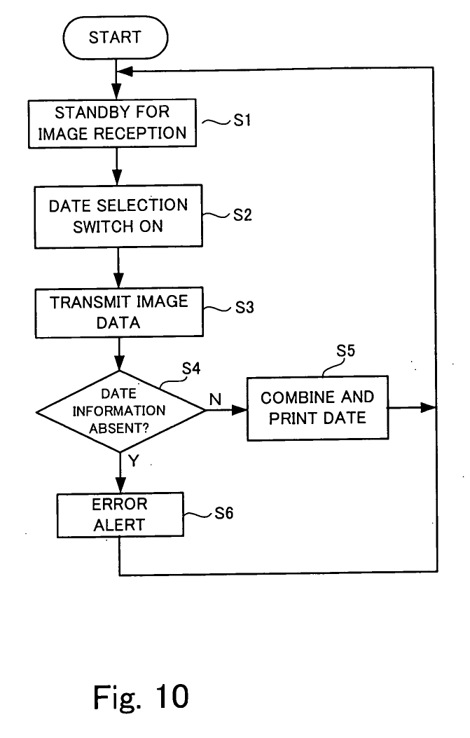

FIG. 10 is a flowchart of a series of processing routines by the printer shown in FIG. 9.

When the power is applied to the printer 1 shown in FIG. 9, the printer 1 is firstly set to an image reception standby state in step S1. Subsequently, the date selection switch 55 is turned on in step S2. In this way, the second recording mode is selected. Now, in step S3, the image data are transmitted from the camera-equipped cellular telephone 10 (see FIG. 2) to the printer 1 by use of the infrared communication.

In step S4, the printer 1 judges whether the date information (the date data) is added or not. When a judgment is made that the date information is added thereto, the process goes to step S5. In step S5, the date is combined and printed. Specifically, both of the image and the date are recorded on the instant photographic sheet 1001. Then, the process returns to step S1. On the contrary, the process goes to step S6 when a judgment is made that the date information is not added thereto. In step S6, an error alert is issued by causing the date section LED 56 to perform a blink display. Thereafter, the process in the flow is terminated.

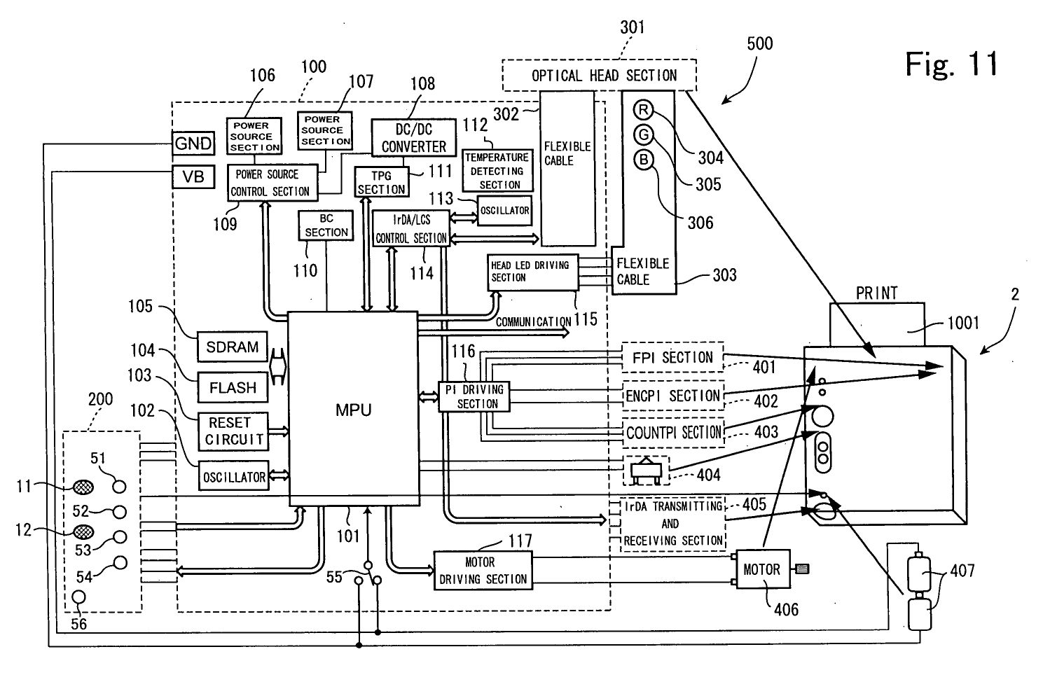

FIG. 11 is a block diagram showing a control system inside a printer according to a second embodiment of the present invention.

Here, an external perspective view of a printer 2 shown in FIG. 11 is the same as the external perspective view of the printer 1 and a similar illustration is omitted herein.

The printer 2 shown in FIG. 11 is different from the printer 1 shown in FIG. 9 in that the image drawing section 300 is replaced by an image drawing section 500. When the image data received by the IrDA transmitting and receiving section 405 represent the image data without addition of the date data even though the date selection switch 55 selects the second recording mode to record the date together with the image based on the image data, the image drawing section 500 performs image drawing in accordance with the first recording mode to draw only the image based on the image data.

There may be a case where a user intends to record the image based on the image data on the instant photographic sheet 1001 even if the image data do not contain the date data. The printer 2 according to the second embodiment of the present invention is configured to perform image drawing in accordance with the first recording mode when the image data received by the IrDA transmitting and receiving section 405 represent the image data without addition of the date data even though the second recording mode is selected. In addition, an error alert is issued to the user. In this way, it is possible to record the image on the instant photographic sheet 1001 based on image data even if the image data do not contain the date data, and the user can confirm the lack of the date data by the alert.

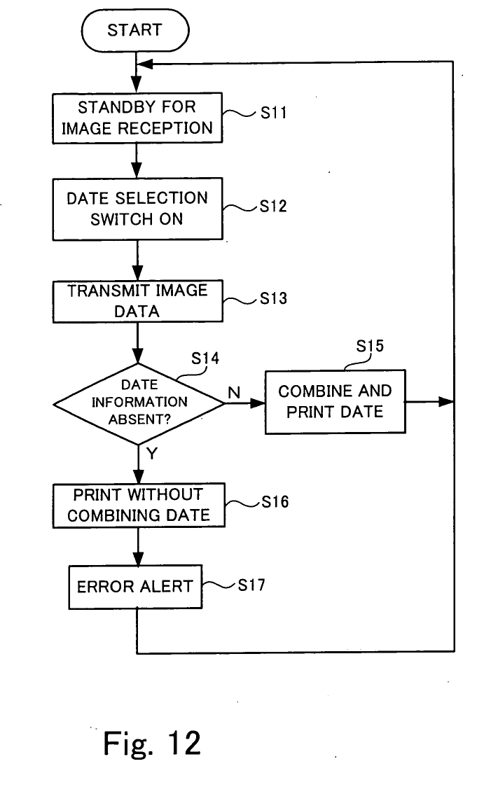

FIG. 12 is a flowchart of a series of processing routines by the printer shown in FIG. 11.

When the power is applied to the printer 2 shown in FIG. 11, the printer 2 is firstly set to the image reception standby state in step S11. Subsequently, the date selection switch 55 is turned on in step S12. In this way, the second recording mode is selected. Further, in step S13, the image data are transmitted from the camera-equipped cellular telephone 10 to the printer 2 by use of the infrared communication.

In step S14, the printer 2 judges whether the date information is added or not. When a judgment is made that the date information is added thereto, the process goes to step S15. In step S15, the date is combined and printed. Specifically, both of the image and the date are recorded on the instant photographic sheet 1001. Then, the process returns to step S11.

On the contrary, the process goes to step S16 when a judgment is made that the date information is not added thereto. In step S16, the image is printed without combining the date. Specifically, only the image is recorded on the instant photographic sheet 1001 without recording the date thereon. Moreover, in step S17, an error alert is issued by causing the date selection LED 56 to perform a blink display. Thereafter, the process in this flow is terminated.

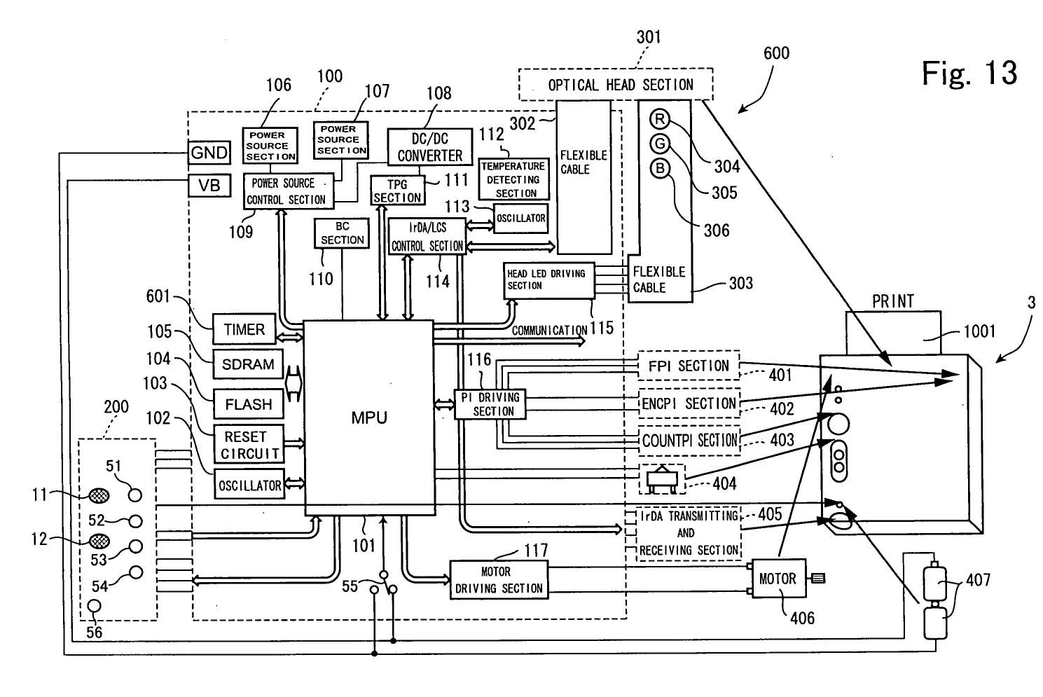

FIG. 13 is a block diagram showing a control system inside a printer according to a third embodiment of the present invention.

Here, an external perspective view of a printer 3 shown in FIG. 13 is the same as the external perspective view of the printer 1 and a similar illustration is omitted herein.

The printer 3 shown in FIG. 13 is different from the printer 1 shown in FIG. 9 in that the image drawing section 300 is replaced by an image drawing section 600, and that a timer 601 for managing a date is added thereto. When the image data received by the IrDA transmitting and receiving section 405 represent the image data without addition of the date data even though the date selection switch 55 selects the second recording mode to record the date together with the image based on the image data, the image drawing section 600 draws the image based on the image data received by the IrDA transmitting and receiving section 405 and the date managed by the timer 601 on the instant photographic sheet 1001.

Moreover, the date selection LED 56 issues an error alert performing a blink display when the image data received by the IrDA transmitting and receiving section 405 represent the image data without addition of the date data even through the date selection switch 55 selects the second recording mode.

This printer 3 is configured to issue the error alert to a user concerning the lack of the date data when the image data received by the IrDA transmitting and receiving section 405 represent the image data without addition of the date data even though the second recording mode to record the date based on the date data together with the image based on the image data is selected. And the printer 3 is adapted to draw the image based on the image data received by the IrDA transmitting and receiving section 405 and the date managed by the timer 601. Accordingly, even if the image data received by the IrDA transmitting and receiving section 405 do not contain the date data, the date is still drawn together with the image based on the image data. Therefore, the image with addition of the date is recorded on the instant photographic sheet 1001 when the user intends to record the image with addition of the date on the instant photographic sheet 1001 even without knowing that the image data do not contain the date data. In this way, it is possible to prevent an image unintended by the user from being recorded on the instant photographic sheet 1001.

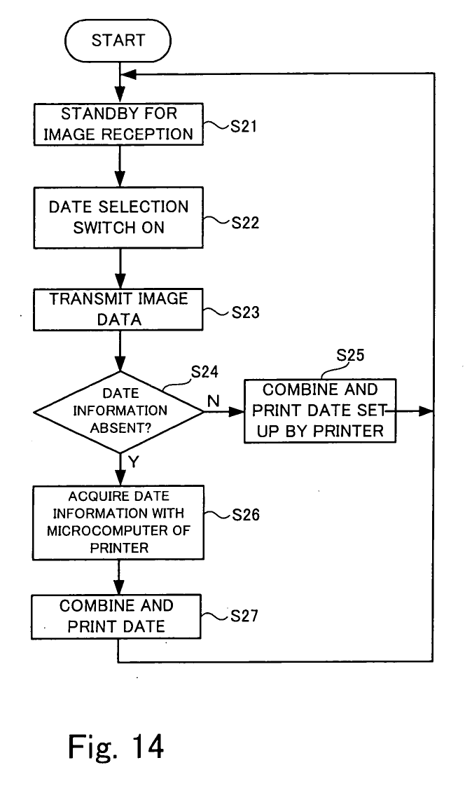

FIG. 14 is a flowchart of a series of processing routines by the printer shown in FIG. 13.

When the power is applied to the printer 3 shown in FIG. 13, the printer 3 is firstly set to the image reception standby state in step S21. Subsequently, the date selection switch 55 is turned on in step S22. In this way, the second recording mode is selected. Further, in step S23, the image data are transmitted from the camera-equipped cellular telephone 10 to the printer 3 by use of the infrared communication.

In step S24, the printer 3 judges whether the date information is added or not. When a judgment is made that the date information is added thereto, the process goes to step S25. In step S25, the date is set up based on the date information and then the date is combined and printed. Specifically, both of the image and the date are recorded on the instant photographic sheet 1001. Then, the process returns to step S21.

On the contrary, the process goes to step S26 when a judgment is made that the date information is not added thereto. In step S26, a microcomputer (the MPU 101) of the printer 3 acquires the date information from the timer 601. Moreover, in step S27, the date is combined and printed. Thereafter, the process in this flow is terminated.

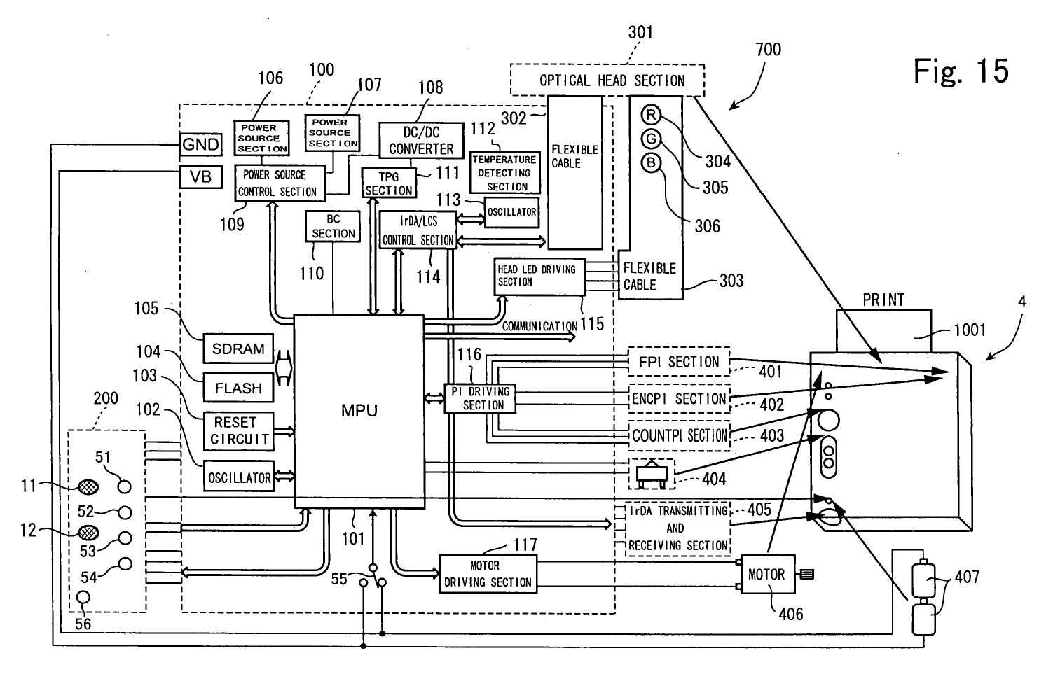

FIG. 15 is a block diagram showing a control system inside a printer according to a fourth embodiment of the present invention.

Here, an external perspective view of a printer 4 shown in FIG. 15 is the same as the external perspective view of the printer 1 and a similar illustration is omitted herein.

A dedicated application program capable of setting date data to the image data is installed in a camera-equipped cellular telephone that transmits the image data to the printer 4. From the camera-equipped cellular telephone, a date setting command and date data set up by the application program are transmitted prior to transmission of the image data.

An IrDA transmitting and receiving section 705 receives the image data as well as the date data and the date setting command independently of the image data. The date data and the date setting command is an example of data corresponding to additional data in the present invention.

An image drawing section 700 draws, together with the image based on the image data received by the IrDA transmitting and receiving section 705, the date based on the date data received prior to the reception of the image data by the IrDA transmitting and receiving section 705 on the instant photographic sheet 1001 as follows.

The date setting command received by the IrDA transmitting and receiving section 705 is decoded by a MPU 701 and the date data are thereby stored in the flash memory 104. Here, the image data represent the image data without addition of the date data even though the date selection switch 55 selects the second recording mode. For this reason, the date selection LED 56 performs a blink display to issue an error alert to a user, and the date is drawn on the instant photographic sheet 1001 together with the image based on the image data.

In this way, the printer 4 is configured to draw, together with the image based on the image data received by the IrDA transmitting and receiving section 705, the date based on the date data received prior to the reception of the image data by the IrDA transmitting and receiving section 705 while causing the date selection LED 56 to perform a blink display. Therefore, even when the image data received by the IrDA transmitting and receiving section 705 do not contain the date data, the date is still drawn together with the image based on the image data. In this way, it is possible to prevent the image without addition of the date from being recorded on the instant photographic sheet 1001.

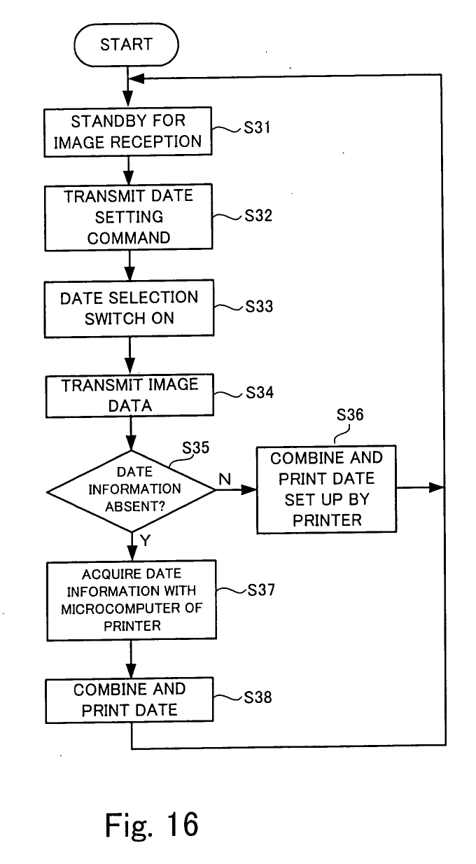

FIG. 16 is a flowchart of a series of processing routines by the printer shown in FIG. 15.

When the power is applied to the printer 4 shown in FIG. 15, the printer 4 is firstly set to the image reception standby state in step S31. Subsequently, the date setting command is transmitted from the camera-equipped cellular telephone in step S32. Moreover, the date selection switch 55 is turned on in step S33. In this way, the second recording mode is selected. Subsequently, in step S34, the image data are transmitted from the camera-equipped cellular telephone to the printer 4.

In step S35, a judgment is made as to whether the date information is added or not. When a judgment is made that the date information is added thereto, the process goes to step S36. In step S36, the date is set up based on the date information and then this date is combined and printed. Specifically, both of the image and the date are recorded on the instant photographic sheet 1001. Then, the process returns to step S31.

On the contrary, the process goes to step S37 when a judgment is made that the date information is not added thereto. In step S37, a microcomputer (the MPU 701) of the printer 4 acquires the date information from the flash memory 104 that was received by the printer 4 prior to the reception of the image data. Moreover, in step S38, this date is combined and printed. Thereafter, the process in this flow is terminated. Here, the MPU 701 incorporates an unillustrated read-only memory (ROM) that stores font data for date printing, and the date based on the font data is printed. Moreover, it is also possible to store font data for comments such as “Happy birthday” in this ROM in addition to the font data for date printing, and to print a comment based on the font data for comments together with the image.

The embodiments have been described on the examples of the printers 1, 2, 3, and 4 configured to draw an image on an instant photographic sheet for recording images while feeding the instant photographic sheet and thereby to record the image on the instant photographic sheet. However, the present invention is not limited only to the foregoing examples. The printer according to the present invention only needs to be configured to draw an image on a recording medium for recording images while feeding the recording medium and thereby to record the image on the recording medium.

What is claimed is:

1. A printer configured to draw an image on a recording medium for recording images while feeding the recording medium and thereby to record the image on the recording medium, the printer comprising:
an image receiving section that receives image data;
a recording mode selecting section that selects either one of a first recording mode and a second recording mode, in the first recording mode only an image based on the image data being recorded, in the second recording mode additional information based on additional data added to the image data being recorded together with the image based on the image data;
an image drawing section that draws either one of the image and both the image and the additional information in accordance with a recording mode selected by the recording mode selecting section; and
an error alerting section that issues an error alert when the image data received by the image receiving section represent the image data without the additional data even though the second recording mode is selected by the recording mode selecting section,
wherein the image drawing section withholds image drawing when the image data received by the image receiving section represent the image data without the additional data even though the second recording mode is selected by the recording mode selecting section.

2. A printer configured to draw an image on a recording medium for recording images while feeding the recording medium and thereby to record the image on the recording medium, the printer comprising:
an image receiving section that receives image data;
a recording mode selecting section that selects either one of a first recording mode and a second recording mode, in the first recording mode only an image based on the image data being recorded, in the second recording mode additional information based on additional data added to the image data being recorded together with the image based on the image data;
an image drawing section that draws either one of the image and both the image and the additional information in accordance with a recording mode selected by the recording mode selecting section; and
an error alerting section that issues an error alert when the image data received by the image receiving section represent the image data without the additional data even though the second recording mode is selected by the recording mode selecting section,
wherein the image drawing section performs image drawing in accordance with the first recording mode when the image data received by the image receiving section represent the image data without the additional data even though the second recording mode is selected by the recording mode selecting section.

3. A printer configured to draw an image on a recording medium for recording images while feeding the recording medium and thereby to record the image on the recording medium, the printer comprising:
an image receiving section that receives image data;
a recording mode selecting section that selects either one of a first recording mode and a second recording mode, in the first recording mode only an image based on the image data being recorded, in the second recording mode additional information based on additional data added to the image data being recorded together with the image based on the image data;
an image drawing section that draws either one of the image and both the image and the additional information in accordance with a recording mode selected by the recording mode selecting section;
an error alerting section that issues an error alert when the image data received by the image receiving section represent the image data without the additional data even though the second recording mode is selected by the recording mode selecting section; and
a timer that manages a date,
wherein the image drawing section draws the date managed by the timer together with the image based on the image data received by the image receiving section when the image data received by the image receiving section represent the image data without addition of the date data even though the second recording mode is selected by the recording mode selecting section.

4. A printer configured to draw an image on a recording medium for recording images while feeding the recording medium and thereby to record the image on the recording medium, the printer comprising:
a receiving section that receives image data which occasionally contain additional data and receives data corresponding to the additional data independently of the image data;
a recording mode selecting section that selects either one of a first recording mode and a second recording mode, in the first recording mode only an image based on the image data being recorded, in the second recording mode additional information based on additional data added to the image data being recorded together with the image based on the image data;
an image drawing section that draws either one of the image and both the image and the additional information in accordance with a recording mode selected by the recording mode selecting section; and
an error alerting section that issues an error alert when the image data received by the receiving section represent the image data without the additional data even though the second recording mode is selected by the recording mode selecting section,
wherein the image drawing section draws additional information based on the data corresponding to the additional data received by the receiving section prior to reception of the image data together with the image based on the image data received by the receiving section.
